(19) United States
(12) Patent Application Publication
(10) Pub. No.: US 2011/0320582 A1
(43) Pub. Date: Dec. 29, 2011

(54) ONLINE PRESENCE MANAGEMENT SYSTEM

(76) Inventor: George C. Lewis, Superior, CO (US)

(21) Appl. No.: 12/822,049

(22) Filed: Jun. 23, 2010

(51) Int. Cl. G06F 15/173

(52) U.S. Cl. 709/224

(57) ABSTRACT

Systems and methods of online presence management are described herein. The online present management systems and methods provide for creating, managing, controlling, and parking accounts on websites such as social networking sites. The embodiments disclosed herein may be used by interested parties and entities to manage their online presence, profiles, and personalities. In other embodiments, the online presence management system may be used to manage ownership of domain names and other online assets.

### CROSS REFERENCE TO RELATED CASES

This patent application claims priority to U.S. Provisional Patent Application No. 61/214,731 filed on Jun. 23, 2004, entitled “ONLINE PRESENCE MANAGEMENT SYSTEM,” which is hereby incorporated by reference in its entirety.

### BACKGROUND

The popularity of social networking sites have grown in popularity in recent years. Each day the number of users and the number users and the number of social networking sites increases. Users of social networking sites often maintain multiple accounts across multiple sites. Due to the number of different sites, it is often hard for users manage all of their accounts across the different sites.

### SUMMARY

In one aspect, the online presence management (OPM) system described herein is a means for creating, managing, controlling and parking accounts on websites, such as social networking and web services sites, for interested parties and/or entities such as businesses. By parking, it is meant keeping an account sufficiently active so that the account remains in existence until such time as the person/entity that caused it to be created is ready to use it or decides it is no longer desired. The OPM system may also be used to manage ownership of domain names and other online assets such as user accounts on Google, Yahoo!, etc.

### BRIEF DESCRIPTION OF THE DRAWINGS

The same number represents the same element or same type of element in all drawings.

FIG. 1 illustrates some of the elements of an embodiment of an OPM system and its computing network environment 100.

FIG. 2 illustrates some of the elements in an embodiment of an OPM 102.

FIG. 3 illustrates an embodiment of a method for managing online presence.

FIG. 4, is an embodiment of a computing environment for implementing the various embodiments described herein includes a computer system, such as computer system 400.

### DETAILED DESCRIPTION

Before the management systems are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a lithium hydroxide” is not to be taken as quantitatively or source limiting, and reference to “a step” may include multiple steps.

In one aspect, the online presence management (OPM) system described herein is a means for creating, managing, controlling and parking accounts on websites, such as social networking and web services sites, for interested parties and/or entities such as businesses. By parking, it is meant keeping an account sufficiently active so that the account remains in existence until such time as the person/entity that caused it to be created is ready to use it or decides it is no longer desired. The OPM system may also be used to manage ownership of domain names and other online assets such as user accounts on Google, Yahoo!, etc.

There are several situations in which such a parking service may be valuable. Social networking in general is becoming more accepted and important in daily life. However, many professionals, celebrities, businesses and other people simply do not have the time or inclination to create and manage numerous accounts on different networks on the off chance that at some point in the future they may want to participate in that social network. For these same people, though, even though they currently do not wish to participate in a particular network, there may be a desire to prevent others from impersonating them on the network. As recent events have shown, the damage that could be caused to one's or one's employer's reputation by imposters on social networks such as Facebook, Twitter, MySpace, and LinkedIn to name but a few (see Appendix A for a more comprehensive list). An aspect of interest in all these networks is that user creates an account which can be (but does not necessarily need to be) associated with a real person or entity in the real world.

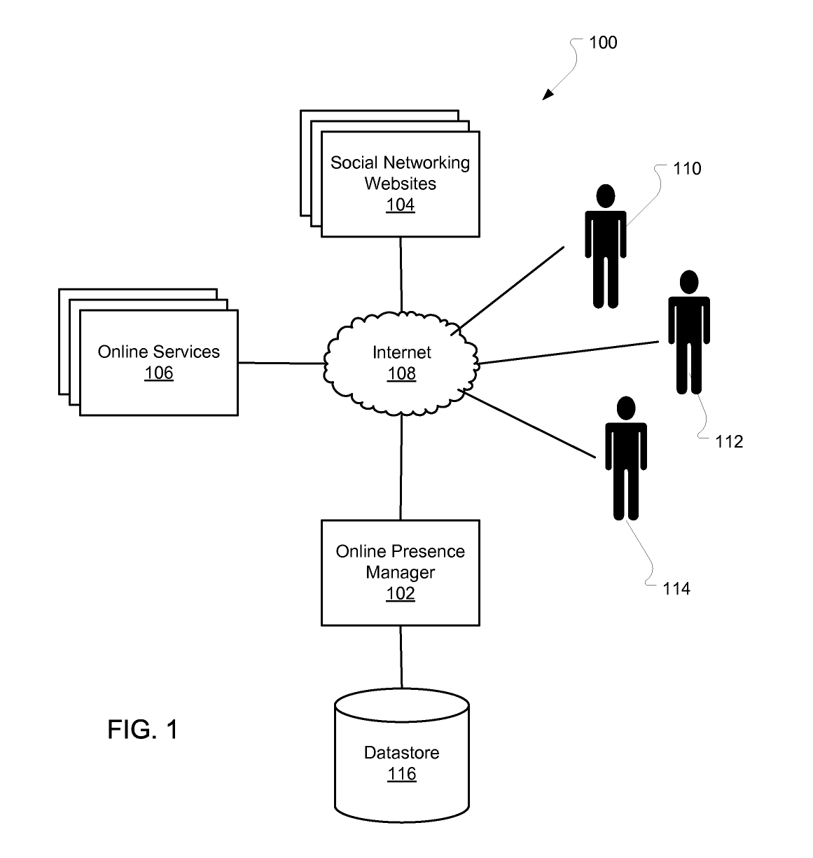

FIG. 1 illustrates some of the elements of an embodiment of an OPM system and its computing network environment 100. The OPM system 102 is connected to social networking websites 104 and web services 106 via the interne 108. The OPM system 102 is also connected to one or more users 110, 112, 114 that wish to control and maintain one or more accounts on the websites 104 and web services 106 with a minimum of interaction.

In order to do this, the OPM system 102 is adapted to create and maintain accounts on the various websites 104 and web services 106. Account information is stored in a secured datastore 116. The account information is used to verify that accounts are not be tampered with and that the accounts are kept active as required by the various websites 104 and web services 106. If and when a user desires to take personal control over a particular account on a particular website 104 or service 106, the OPM 102 effects the transfer of control to the user.

Through the OPM 102, a user may select specific sites/services, usernames for the accounts on the sites/services and specific content to be placed on a parked account. The user may provide pre-existing accounts or the OPM 102 may create new accounts, with or without the user's direct input. For example, in an embodiment the OPM 102 may provide suggestions of different available usernames or other account identifiers based on what names are available by trying number permutations of a desired username provided by the user.

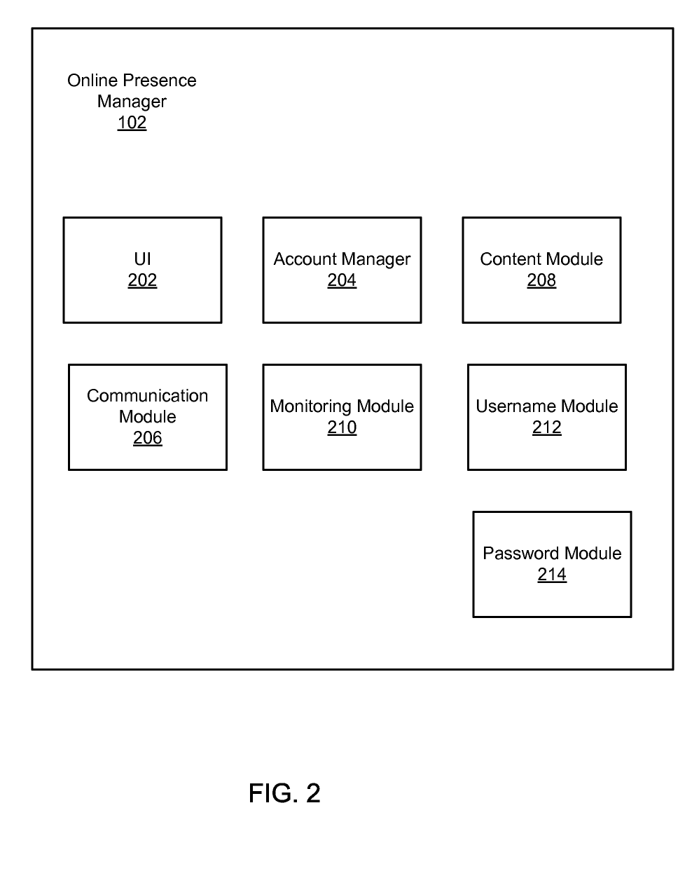

FIG. 2 illustrates some of the elements in an embodiment of an OPM 102. The OPM 102 includes a user interface 202 for communicating with users 110, 112, 114. The UI 202 may be connected to the account manager module 204 directly or through a communication module 206 that handles all communications between the OPM 102 and external computing systems (e.g., websites and services) and users (via their proxy devices such as mobile phones, laptops, computing devices, etc.).

The account manager 204 receives requests from users and manages accounts on selected websites 104 and web services 106 via the internet 108. As part of the management, the account manager 204 may use a content module 208 to generate content for any and all accounts. Such content may be a generic notification that the site is not in use, that the site is the official site of a specified user and/or directing the viewer to go to a different site that is in use (e.g., “this is the official LinkedIn site for George Washington, First President of the United States. This site is currently not in use. Please see by Facebook page here or my website at www.georgewashington.com.”) The content may be content provided by the user or generated automatically by the content module 208 based on the user's instructions or by default.

The account manager 204 may also use a username module 212 to generate a username or other account login name for any and all accounts. Depending on the website/service such a username may be an important aspect of the account which is used to identify the user to the public. In other situations, usernames may not be “outward facing” (that is, viewable to other users of the service) and there is no importance of getting a descriptive username, in which case the username may be chosen at random. Usernames may be provided by the user or generated automatically by the username module 212 based on the user's instructions or by default.

The account manager 204 may also use a password module 214 to generate a password or other account login name for any and all accounts. The passwords may be the same for each user or may be different for each account. In an embodiment, the password module 214 creates a randomly generated password have a large number of characters to increase the strength of the password. For example, in an embodiment passwords may be generated for each account that has the maximum number of characters supported by the website/service. Other rules may also be followed including requiring that the password:
Be 4-64 or more characters long,
Contain both uppercase and lowercase letters.
Contain numbers.
Contain symbols, such as ′!″?$?%̂&*( )_−+={[}]:;@′˜#|\<,>.?/
Contain a symbol in the second, third, fourth, fifth or sixth position (due to the way in which encryption works).
Not resemble any of your previous passwords.
Not be your name, your friend's or family member's name, or your login.
Not be a dictionary word or common name.

The password module 214 may include a strong password generator and may be periodically employed by the account manager 204 to update and change all existing passwords for all accounts managed by the OPM. Passwords may or may not be provided to a particular user. In an embodiment, because the passwords are automatically changed by the OPM as part of the ongoing management of the accounts, passwords are only provided to users when a user requests to take personal control of an account. In this case, the password generator may generate one more password for the account and provide this new password to the user as part of the account transfer process.

The OPM may further include a monitoring module 210 that monitors the content on any managed accounts to make sure the content on the account does not change except when changed by the OPM. This may include monitoring information received through the communication module 206 from the websites/services that are notifications of changes to the accounts on those websites/services. The monitoring module 210 may include one or more automated crawlers that inspect the content of the website/service associated with an account to confirm that the site ahs not changed or that changes instigated by the OPM have been put in place.

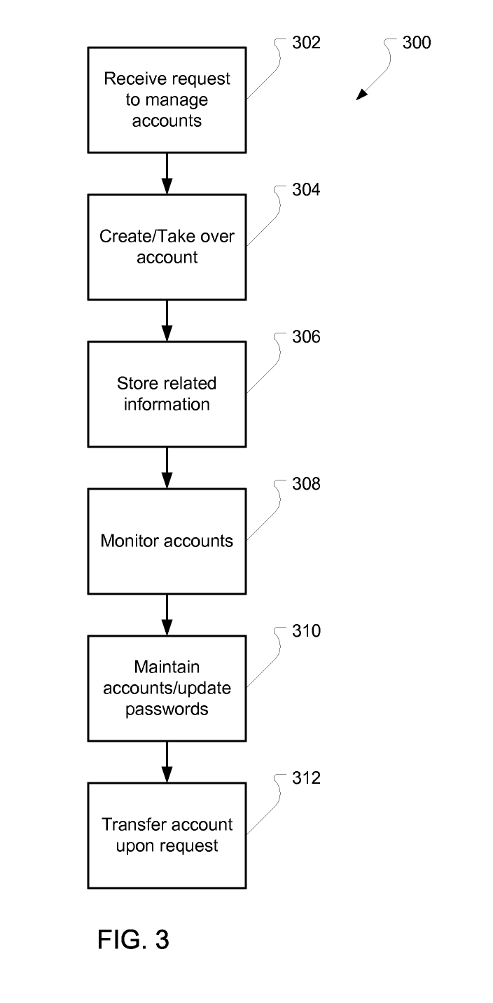

FIG. 3 illustrates an embodiment of a method for managing online presence. In the embodiment shown, the method 300 starts with the receipt of a request to manage one or more accounts on one or more websites/services in a receive request operation 302. The request may be received via the OPM's UI directly from a user or from another input system.

The request may identify specific websites/services to be managed, whether existing accounts should be taken over by the OPM (along with the necessary information such as username and current password), whether new accounts should be created, any content that should be posted on any of the websites/services, and any directions concerning preferred usernames where applicable.

For example, a request may be to create accounts on the top ten social network sites and one specified site and take over two existing domain names and a Twitter account for a particular sports celebrity. The request may include the name of the specified site, the username, registration and other hosting information related to the domain names and Twitter account necessary for the OPM to gain access and take control of the existing accounts.

For websites/services that have specific procedures for parked accounts, the OPM may utilize those procedures. Alternatively, the OPM may access a website/service via its normal user portal and create a new account as if it were the user creating a new account.

Next, the appropriate accounts are created or taken control as dictated by the request in the create/take over account operation 304. In an embodiment, the create/take over account operation 304 includes the generation of new passwords for each account whether it is newly created by the OPM or pre-existing. In addition, the contact and notification information for each account is updated so that the OPM is designated to receive notifications, emails, text messages, etc. from each account.

In an embodiment, a user may designate that all communications with parked accounts go to the OPM or may request to have some or all communications sent to the user directly from the website/service or via OPM. If through the OPM, the OPM may screen or otherwise filter communications as directed by the user so that only communications of interest reach the user and the user's communication means remain secret (email addresses, phone numbers, etc.).

All the account information associated with the user is then stored in a secure database in a storage operation 306. This information may include passwords, usernames, contact information for the user and content provided by the user or generated by the OPM.

The OPM then monitors the accounts under management over time as illustrated by the monitor operation 308. This includes ensuring that none of the accounts change unexpectedly as well as ensuring that desired changes are made. For example, the content of parked domain names may be periodically checked to make sure that the webpages have not been hacked and replaced with offensive material. Likewise, communications from the websites/services may be monitored for unexpected change notifications that may indicate that someone has hacked an account.

The OPM also actively maintains the accounts under management as illustrated by the maintain operation 310. This includes periodically changing passwords, such as changing passwords every two weeks or when a hacking has been detected. In an embodiment, maintenance also includes any periodic access or content change that may be required by each website/service in order to meet the activity requirements imposed on the account. This may also include the periodic payment of fees, confirmation of registration and communication information, changing or updating of content, deletion of messages from inboxes, as well as any other periodic maintenance imposed by the website/service.

Ultimately, a user may wish to take active control of an account. This is illustrated by the transfer operation 312. This may include receiving a request from the user to transfer some or all accounts associated with the user. In an embodiment, the OPM responds by verifying that the request is genuine and transmitting all necessary information to the user for the user to take over control of the accounts. In an alternative embodiment, the OPM may update all information in the requested account(s) as directed by the user, for example resetting the password to a user selected password, updating the communication information to information provided by the user, uploading content provided by the user, etc. so that upon completion, the user is in control of the specified account(s).

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternate embodiments having fewer than or more than all of the features herein described are possible.

It should be noted that many of the actions described above could be performed by a autonomous computer application or by an employee of the operator of the OPM. For example, in an embodiment, new accounts may be created by a human account manager but then monitored and maintained by an automated system. Likewise, requests may be received by a receptionist that takes the necessary information from the user and works with the user to ensure adequate transfer of all existing accounts and the creation of the accounts desired by the user. Humans may also be fundamental in resolving issues identified when the ongoing monitoring identifies unexpected changes in accounts. In such embodiments, the human support is considered an integral part of the system, as integral as a human chemist mixing reagents in a method or system of producing chemical products.

While various embodiments have been described for purposes of this disclosure, various changes and modifications may be made which are well within the scope of the present invention. For example, bank accounts for which a user does not expect to access may be securely parked using the OPM described. This is also true of cell phone accounts, forum accounts or any online account that can be managed electronically. Numerous other changes may be made which will readily suggest themselves to those skilled in the art and which are encompassed in the spirit of the disclosure.

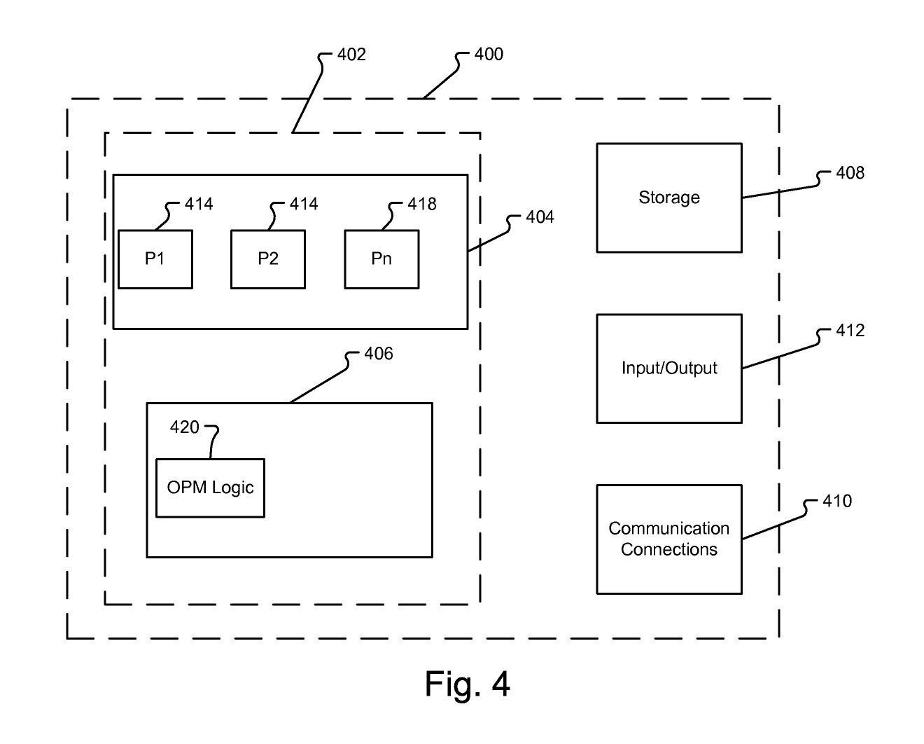

With reference to FIG. 4, an embodiment of a computing environment for implementing the various embodiments described herein includes a computer system, such as computer system 400. For example, a computer system 400 may be used to perform the OPM methods disclosed herein. Any and all components of the described embodiments may execute on a client computer system, a server computer system, a combination of client and server computer systems, a handheld device, and other possible computing environments or systems described herein. As such, a basic computer system applicable to all these environments is described hereinafter.

In its most basic configuration, computer system 400 comprises at least one processing unit or processor 404 and system memory 406. The most basic configuration of the computer system 400 is illustrated in FIG. 4 by dashed line 402. In some embodiments, one or more components of the described system are loaded into system memory 406 and executed by the processing unit 404 from system memory 406. Depending on the exact configuration and type of computer system 400, system memory 406 may be volatile (such as RAM), non-volatile (such as ROM, flash memory, etc.), or some combination of the two.

Additionally, computer system 400 may also have additional features/functionality. For example, computer system 400 includes additional storage media 408, such as removable and/or non-removable storage, including, but not limited to, magnetic or optical disks or tape. In some embodiments, software or executable code and any data used for the described system is permanently stored in storage media 408. Storage media 408 includes volatile and non-volatile, removable and non-removable media implemented in any method or technology for storage of information such as computer readable instructions, data structures, program modules, or other data. In embodiments, instructions to perform the methods disclosed herein are stored in storage media 408.

System memory 406 and storage media 408 are examples of computer storage media. Computer storage media includes, but is not limited to, non-transitory storage media, such as RAM, ROM, EEPROM, flash memory or other memory technology, CD-ROM, digital versatile disks (DVD) or other optical storage, magnetic cassettes, magnetic tape, magnetic disk storage, other magnetic storage devices, or any other medium which is used to store the desired information and which is accessed by computer system 400 and processor group 404. Any such computer storage media may be part of computer system 400. In embodiments, system memory 406 and/or storage media 408 stores data and instructions used to perform the methods or form the system(s) disclosed herein. In embodiments, OPM instructions 420 may contain logic to perform the methods disclosed herein.

Computer system 400 may also contain a processor, such as processor P1 414. Processor group 404 is operable to perform the operations necessary to perform the methods disclosed herein. For example, processor group 404 may perform the operations of the various online presence management methods and processes. In one embodiment, processor group 404 may comprise a single processor, such as processor P1 414. In other embodiments, processor group 404 may comprise multiple processors, such as processors P1 414, P2 416, and Pn 418, such as in a multiprocessor system. One of skill in the art will recognize that any number of processor may comprise processor group 404. One skilled in the art will appreciate that any method, process, operation, or procedure disclosed herein may be individually processed by a dedicated processor.

Computer system 400 may also contain communications connection(s) 410 that allow the device to communicate with other devices. Communication connection(s) 410 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media.

In embodiments, communications connection(s) 410 may allow communication with other systems containing processors. In such an embodiment, a distributed network may be created upon which the disclosed methods and processes may be employed. One skilled in the art will appreciate that any method, process, operation, or procedure disclosed herein may be individually processed by a dedicated computer, node, or processor in a distributed network.

In some embodiments, computer system 400 also includes input and output connections 412, and interfaces and peripheral devices, such as a graphical user interface. Input device(s) are also referred to as user interface selection devices and include, but are not limited to, a keyboard, a mouse, a pen, a voice input device, a touch input device, etc. Output device(s) are also referred to as displays and include, but are not limited to, cathode ray tube displays, plasma screen displays, liquid crystal screen displays, speakers, printers, etc. These devices, either individually or in combination, connected to input and output connections 412 are used to display the information as described herein. All these devices are well known in the art and need not be discussed at length here.

In some embodiments, the component described herein comprise such modules or instructions executable by computer system 400 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 400 is part of a network that stores data in remote storage media for use by the computer system 400.

This disclosure describes some embodiments of the present invention with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present invention. Therefore, the specific structure, acts, or media are disclosed only as illustrative embodiments. The invention is defined by the appended claims.

What is claimed is:

1. A method of online presence management, the method comprising:
receiving a request to manage an account;
creating an account;
storing information related to the account;
monitoring the account; and
transferring the account upon request.
